(19) United States
(12) Patent Application Publication
(10) Pub. No.: US 2026/0138081 A1
(43) Pub. Date: May 21, 2026

(54) PROCESS AND APPARATUS FOR SEPARATING A FEED FLOW CONTAINING HYDROGEN, CARBON DIOXIDE, AND AT LEAST ONE OF THE COMPONENTS CHOSEN FROM THE LIST OF CARBON MONOXIDE, METHANE OR NITROGEN

(71) Applicant: L'Air Liquide, Societe Anonyme pour l'Etude et l’Exploitation des Procedes Georges Claude, Paris (FR)

(72) Inventors: Mathieu LECLERC, Champigny-Sur-Marne (FR); Charles BIGNAUD, Champigny-Sur-Marne (FR)

(21) Appl. No.: 19/108,721

(22) PCT Filed: Aug. 29, 2023
(86) PCT No.: PCT/EP2023/073739

§ 371 Date: Feb. 9, 2026

(30) Foreign Application Priority Data
Sep. 8, 2022 (FR) FR2208988

(51) Int. Cl. B01D 53/22; B01D 53/00; B01D 53/047

(52) U.S. Cl. CPC B01D 53/229; B01D 53/002; B01D 53/047; B01D 53/226; B01D 2256/16; B01D 2256/22; B01D 2257/102; B01D 2257/502; B01D 2257/7025; B01D 2257/80

(57) ABSTRACT

In a process for separating a feed flow containing hydrogen, carbon dioxide and at least one of the components chosen from the list of carbon monoxide, methane or nitrogen, a feed flow is separated forming a mixture (1) containing predominantly hydrogen, carbon dioxide and at least one of the components chosen from the list of carbon monoxide, methane or nitrogen and the mixture is separated by membrane separation in a membrane system (M1, M2) comprising a turbine (T1, T2) coupled with at least one booster compressor (C1, C2).

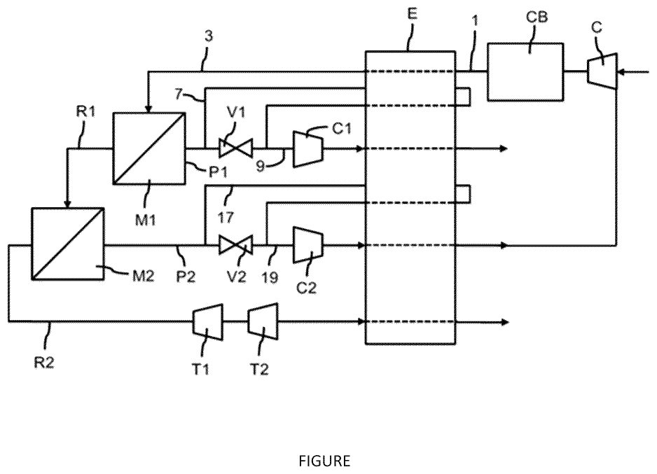

### CROSS REFERENCE TO RELATED APPLICATIONS

This application is a § 371 of International PCT Application PCT/EP2023/073739, filed Aug. 29, 2023, which claims the benefit of FR2208988, filed Sep. 8, 2022, both of which are herein incorporated by reference in their entireties.

### FIELD OF THE INVENTION

The present invention relates to a process and apparatus for separating a feed flow containing hydrogen, carbon dioxide, and at least one of the components chosen from the list of carbon monoxide, methane or nitrogen. The process comprises a step of membrane separation of a mixture containing predominantly hydrogen and carbon dioxide and, in addition, at least one other component chosen from carbon monoxide, methane and nitrogen.

### BACKGROUND OF THE INVENTION

A mixture containing predominantly hydrogen and carbon dioxide has a composition such that at least 50 mol % of the mixture is composed of hydrogen and carbon dioxide.

The capture of carbon dioxide (CO₂) by a distillation and/or partial condensation process fed by a residual gas from a hydrogen (H₂) production unit comprising a pressure swing adsorption (PSA) hydrogen separation unit is known. The residual gas is depleted in hydrogen relative to the gas feeding this separation unit. The separation unit can be combined with membrane separation of the gas depleted in carbon dioxide produced by the distillation and/or partial condensation process. The aim of these membranes is to separate the CO₂ and H₂ from the rest of the gases in two steps. The permeate of the first membrane is recycled to the PSA, whereas the permeate of the second membrane is itself returned to the compression upstream of the separation by distillation and/or partial condensation so as to be compressed. The residue of the membranes is still under pressure: it is expanded by a valve before regenerating the dryers. This energy could be recovered so as to improve the efficiency of this CO₂ capture process. U.S. Pat. No. 4,639,257 describes the passage of the residual gas from the cryogenic separation through an economizer before being sent to a first membrane. The permeate of this first membrane is recycled upstream of a compressor of the gas feeding the cryogenic separation.

### SUMMARY OF THE INVENTION

The invention proposes an improved process with a scheme for integration of at least one turbine coupled with at least one booster so as to better exploit the energy of the expansion of the second residue of the membranes.

According to one subject of the invention, there is provided a process for separating a feed flow containing hydrogen, carbon dioxide, and at least one of the components chosen from the list of carbon monoxide, methane or nitrogen and optionally water, comprising the following steps:
a) Compression of the feed flow in a compressor, purification with water of the feed flow in an adsorption purification unit, and/or cooling of the flow purified of water in an exchange line, separation of the purified and/or cooled feed flow by partial condensation and/or distillation so as to form a flow rich in carbon dioxide and a mixture containing predominantly hydrogen, carbon dioxide and at least one of the components chosen from the list of carbon monoxide, methane or nitrogen and
b) Separation of the mixture by a membrane separation process comprising the following steps:
   i. optionally, heating of the mixture in a heat exchanger up to a temperature between 6° and 100° C.
   ii. permeation of the mixture, which is optionally heated, through a first membrane making it possible to obtain a first permeate enriched in hydrogen and carbon dioxide relative to the mixture and a first residue depleted in hydrogen and carbon dioxide relative to the mixture.
   iii. optionally, cooling of at least a part of the first permeate in the heat exchanger.
   iv. compression of the first permeate, which is optionally cooled, in a first booster.
   v. optionally, cooling of at least a part of the first permeate compressed in the first booster in the heat exchanger.
   vi. permeation of the first residue, preferably without having cooled it, through a second membrane making it possible to obtain a second permeate enriched in hydrogen and carbon dioxide relative to the first residue and a second residue depleted in hydrogen and carbon dioxide relative to the first residue.
   vii. optionally, cooling of at least a part of the second permeate in the heat exchanger.
   viii. compression of the second permeate, which is optionally cooled, in a second booster.
   ix. optionally, cooling of at least a part of the compressed second permeate in the heat exchanger, and
   x. expansion of the second residue in at least one turbine driving the first and/or the second booster.

According to other optional aspects:
at least a part of the expanded second residue is sent to the purification unit as regeneration gas.
at least a part of the expanded second residue is sent to contribute cold to the exchange line.
at least a part of the expanded second residue is sent to burners of a reformer.
the mixture is heated in the heat exchanger, optionally up to a temperature between 6° and 100° C.
the mixture is heated by indirect heat exchange in the heat exchanger with at least a part of at least one of the following flows: first permeate, first residue, second permeate, second residue.
the second residue is expanded in two turbines in series, each of which drives one of the first and second boosters.
the second residue expanded in the two turbines is, after the expansion, at a pressure between 3 and 5 bara and/or a temperature of between −30 and −55° C.
the feed flow is compressed in a compressor upstream of the partial condensation and/or distillation and the second permeate compressed by the second booster is sent to be compressed in the compressor.
the second residue is enriched in carbon monoxide and/or methane and/or nitrogen relative to the first residue

According to another subject of the invention, there is provided an apparatus for separating a feed flow containing hydrogen, carbon dioxide and at least one of the components chosen from the list of carbon monoxide, methane or nitrogen, comprising a compressor, a purification unit and/or an exchange line, means for sending the feed flow compressed in the compressor to the purification unit and/or to the exchange line, a unit for separating the purified and/or cooled feed flow by partial condensation and/or distillation so as to form a flow rich in carbon dioxide and a mixture containing predominantly hydrogen, carbon dioxide and at least one of the components chosen from the list of carbon monoxide, methane or nitrogen, means for sending the feed flow from the purification unit and/or the exchange line to the separation unit, a membrane separation apparatus comprising a first membrane, a duct for sending mixture to be separated to the first membrane making it possible to obtain a first permeate enriched in hydrogen and carbon dioxide relative to the mixture and a first residue depleted in hydrogen and carbon dioxide relative to the mixture, a first booster, a duct for sending first permeate to the first booster so as to be compressed, a second membrane, a duct for sending first residue, preferably without having cooled it, to the second membrane making it possible to obtain a second permeate enriched in hydrogen and carbon dioxide relative to the first residue and a second residue depleted in hydrogen and carbon dioxide relative to the first residue, a second booster, a duct for sending second permeate to the second booster, at least one expansion turbine connected so as to expand the second residue and drive the first and/or the second booster.

According to other optional features, the apparatus comprises:
means for sending second residue from the at least one expansion turbine to the purification unit as regeneration gas.
means for sending second residue from the at least one expansion turbine to the exchange line so as to contribute cold.
means for sending second residue from the at least one expansion turbine to burners of a reformer.
the feed flow is a residual gas from a pressure swing adsorption unit.
the purification unit and means for sending the feed flow compressed in the compressor to the purification unit.
the exchange line and means for sending the feed flow compressed in the compressor to the exchange line.

Preferably, the apparatus comprises two expansion turbines in series, connected so as to each drive one of the first and second boosters.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The FIGURE depicts a separation process according to the invention.

### DETAILED DESCRIPTION OF THE INVENTION

A hydrogen (H₂) production unit comprising a pressure swing adsorption (PSA) hydrogen separation unit produces a gas rich in hydrogen and a residual gas depleted in hydrogen relative to the feed gas but also containing carbon dioxide and nitrogen and/or methane and/or carbon monoxide.

The residual gas is compressed by a compressor C, dried by dryers of an adsorption purification unit, cooled in a heat exchanger referred to as exchange line and then separated by partial condensation and/or distillation so as to produce a fluid rich in carbon dioxide and a gas 1 depleted in carbon dioxide. This fluid and the gas are heated in the exchange line. This separation at low temperature is denoted by the acronym CB.

This gas 1 depleted in carbon dioxide nevertheless contains carbon dioxide, hydrogen and nitrogen and/or methane and/or carbon monoxide.

The gas 1 that is at a pressure between 40 and 70 bara and a temperature between 0 and 50° C. is optionally heated in a heat exchanger E up to a temperature between 6° and 100° C. and more preferentially between 65 and 90° C.

At this temperature and this pressure or otherwise without having been heated, it is separated by permeation through a first membrane M1 so as to produce a first permeate P1 enriched in hydrogen and carbon dioxide relative to the mixture and depleted in nitrogen and/or carbon monoxide and/or methane relative to the mixture at between 15 and 30 bara and more specifically between 17 and 25 bara, which is lower than the inlet pressure of the pressure swing adsorption hydrogen separation unit.

The first permeate P1 is therefore compressed in a booster C1 so as to reach a pressure sufficient to recycle it upstream of the PSA between 20 and 40 bara and more specifically between 20 and 30 bara. Then all or a part of the permeate can be cooled in the heat exchanger E and is sent to be separated in the pressure swing adsorption hydrogen separation unit.

The first residue R1 depleted in hydrogen and carbon dioxide and enriched in nitrogen and/or carbon monoxide and/or methane of the first membrane is sent to a second membrane M2.

The pressure of the second permeate P2, enriched in hydrogen and carbon dioxide and depleted in nitrogen and/or carbon monoxide and/or methane, produced by the second membrane M2 is lower than the pressure of the stage of the compressor C toward which it is recycled: this pressure is between 4 and 11 bara and more specifically between 5 and 9 bara.

The second permeate P2 is therefore compressed in a second booster C2 so as to reach a pressure sufficient to recycle it to a stage of the compressor C upstream of the cryogenic separation so as to obtain a pressure between 5 and 15 bara and more specifically between 8 and 11 bara. All or a part of the second permeate P2 can be cooled in the heat exchanger E and is preferably sent to the inlet of the compressor C.

The second residue depleted in hydrogen and carbon dioxide and enriched in nitrogen and/or carbon monoxide and/or methane produced by the second membrane M2 is expanded in at least one turbine, in this case two turbines in series T1 and T2 that drive the two boosters C1, C2 so as to obtain a gas at low pressure (3-5 bara) and with a low temperature of between −30 and −55° C.

This gas R2 expanded in the two turbines T1, T2 can be used to regenerate the dryers upstream of the cold separation.

The following steps of the method, which are described above, are in fact optional:
Heating of the residual gas 1 originating from the separation by distillation and/or partial condensation through an exchanger E before the first membrane separation so as to reach a temperature between 6° and 100° C. and more preferentially between 65 and 90° C.
Cooling of the first permeate P1 through the exchanger E so as to reach a temperature between 15 and 80° C. before the compression thereof. This step can be carried out as illustrated by cooling only a part 7 of the permeate P1 down to a colder temperature (between 15 and 30° C. for example), which is then combined with the remainder of the permeate.
Cooling of all or a part of the gas at the outlet of the first booster C1 in the heat exchanger E before recycling upstream of the PSA so as to reach a temperature range between 1° and 50° C. and more specifically between 2° and 40° C.
Cooling of the second permeate P2 through the heat exchanger E so as to reach a temperature between 1° and 50° C. This step can be carried out by cooling only a part 17 of the permeate down to a colder temperature (between 15 and 30° C. for example), which is then combined with the remainder of the hot permeate.
Cooling of all or part of the gas at the outlet of the second booster in the exchanger E before recycling upstream of the cryogenic separation so as to reach a temperature between 2° and 80° C. and more specifically between 3° and 70° C.
Sending of the cold gas at the outlet of the second turbine T2 to the main exchanger of the cryogenic separation where the feed gas originating from a hydrogen (H₂) production unit comprising a pressure swing adsorption hydrogen separation unit is cooled.

A variant is possible:
Adding a heater downstream of the turbines T1, T2 so as to obtain a hotter gas at the inlet of the turbines. In this case, the gas at the outlet of the second turbine is not sent to the cryogenic part.

This arrangement makes it possible to lower the pressure of the two permeates, for example by recycling the first permeate to the PSA and the second to the same stage of the machine upstream of the cryogenic separation, by virtue of the boosters. Decreasing the pressure of the permeates generates higher pressure ratios across the two membranes, and this increases the separation efficiency of the membranes.

This invention can be used in two different ways: either by keeping the number of membranes constant (which makes it possible to obtain better CO₂ and H₂ yields (with marginal specific energy cost), or else by decreasing the number of membranes so as to obtain yields similar to the configuration without turbomachine (in this case the specific CO₂ capture energy is reduced).

The following table illustrates the differences in yields of the membranes according to the invention and without the turbine driving the booster with the same membrane surface area and the same composition at the inlet of the membranes.

At the first stage M1, the yields are improved between 14 and 15% respectively for the H₂ and CO₂.

At the second stage M2, the yields are improved between 6 and 10% respectively for the H₂ and CO₂.

TABLE 1
Yields for the permeate P1, P2

| | | Prior art | Invention | % |
|---|---|---|---|---|
| M1 | | | | |
| CO₂ yield | % | 64 | 74 | 15% |
| H₂ yield | % | 75 | 86 | 14% |
| M2 | | | | |
| CO₂ yield | % | 76 | 84 | 10% |
| H₂ yield | % | 88 | 94 | 6% |

At least a part of the second residue R2 expanded in the at least one turbine T1, T2 is sent to the purification unit as regeneration gas and/or at least a part of the expanded second residue R2 is sent to contribute cold to the exchange line E and/or at least a part of the expanded second residue is sent to burners of a reformer. This reformer can feed a PSA of which the residual is the gas sent to the compressor C.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for separating a feed flow containing hydrogen, carbon dioxide, and at least one of the components chosen from the list of carbon monoxide, methane or nitrogen and optionally water, comprising the following steps:
a) Compression of the feed flow in a compressor (C), purification of the feed flow with water in an adsorption purification unit, and/or cooling of the flow purified of water in an exchange line, separation of the purified and/or cooled feed flow by partial condensation and/or distillation (CB) so as to form a flow rich in carbon dioxide and a mixture (1) containing predominantly hydrogen, carbon dioxide and at least one of the components chosen from the list of carbon monoxide, methane or nitrogen and
b) Separation of the mixture by a membrane separation process comprising the following steps:
i) optionally, heating of the mixture (1) in a heat exchanger (E) up to a temperature between 6° and 100° C.
ii) permeation of the mixture (3), which is optionally heated, through a first membrane (M1) making it possible to obtain a first permeate (P1) enriched in hydrogen and carbon dioxide relative to the mixture and a first residue (R1) depleted in hydrogen and carbon dioxide relative to the mixture.
iii) optionally, cooling of at least a part of the first permeate in the heat exchanger.
iv) compression of the first permeate, which is optionally cooled, in a first booster (C1).
v) optionally, cooling of at least a part of the first permeate compressed in the first booster in the heat exchanger
vi) permeation of the first residue, preferably without having cooled it, through a second membrane (M2) making it possible to obtain a second permeate (P2) enriched in hydrogen and carbon dioxide relative to the first residue and a second residue (R2) depleted in hydrogen and carbon dioxide relative to the first residue.
vii) optionally, cooling of at least a part of the second permeate in the heat exchanger
viii) compression of the second permeate, which is optionally cooled, in a second booster (C2)
ix) optionally, cooling of at least a part of the compressed second permeate in the heat exchanger, and
x) expansion of the second residue in at least one turbine (T1, T2) driving the first and/or the second booster.

2. The process as claimed in claim 1, wherein at least a part of the expanded second residue (R2) is sent to the purification unit as regeneration gas and/or at least a part of the expanded second residue is sent to contribute cold to the exchange line and/or at least a part of the expanded second residue is sent to burners of a reformer.

3. The process as claimed in claim 1 or 2, wherein the mixture (3) is heated in the heat exchanger (E), optionally up to a temperature between 6° and 100° C.

4. The process as claimed in claim 3, wherein the mixture (1) is heated by indirect heat exchange in the heat exchanger with at least a part of at least one of the following flows: first permeate (P1), first residue (R1), second permeate (P2), second residue (R2).

5. The process as claimed in one of the preceding claims, wherein the second residue is expanded in two turbines (T1, T2) in series, each of which drives one of the first and second boosters (C1, C2).

6. The process as claimed in claim 5, wherein the residue (R2) expanded in the two turbines (T1, T2) is, after the expansion, at a pressure between 3 and 5 bara and/or a temperature of between −30 and −55° C.

7. The process as claimed in one of claims 1 to 6, wherein the feed flow is compressed in a compressor (C) upstream of the partial condensation and/or distillation (CB) and the second permeate (P2) compressed by the second booster (C2) is sent to be compressed in the compressor.

8. An apparatus for separating a feed flow containing hydrogen, carbon dioxide and at least one of the components chosen from the list of carbon monoxide, methane or nitrogen, comprising a compressor (C), a purification unit and/or an exchange line (E), means for sending the feed flow compressed in the compressor to the purification unit and/or to the exchange line, a unit for separating the purified and/or cooled feed flow by partial condensation and/or distillation (CB) so as to form a flow rich in carbon dioxide and a mixture (1) containing predominantly hydrogen, carbon dioxide and at least one of the components chosen from the list of carbon monoxide, methane or nitrogen, means for sending the feed flow from the purification unit and/or the exchange line to the separation unit, a membrane separation apparatus comprising a first membrane (M1), a duct for sending mixture to be separated to the first membrane making it possible to obtain a first permeate (P1) enriched in hydrogen and carbon dioxide relative to the mixture and a first residue (R1) depleted in hydrogen and carbon dioxide relative to the mixture, a first booster (C1), a duct for sending first permeate to the first booster so as to be compressed, a second membrane (M2), a duct for sending first residue, preferably without having cooled it, to the second membrane making it possible to obtain a second permeate (P2) enriched in hydrogen and carbon dioxide relative to the first residue and a second residue (R2) depleted in hydrogen and carbon dioxide relative to the first residue, a second booster (C2), a duct for sending second permeate to the second booster, at least one expansion turbine (T1, T2) connected so as to expand the second residue and drive the first and/or the second booster.

9. The apparatus as claimed in claim 8, comprising means for sending second residue (R2) from the at least one expansion turbine (T1, T2) to the purification unit as regeneration gas.

10. The apparatus as claimed in claim 8 or 9, comprising means for sending second residue (R2) from the at least one expansion turbine (T1, T2) to the exchange line (E) so as to contribute cold.

11. The apparatus as claimed in claim 8 or 9 or 10, comprising means for sending second residue (R2) from the at least one expansion turbine (T1, T2) to burners of a reformer.

12. The apparatus as claimed in one of claims 8 to 11, wherein the feed flow is a residual gas from a pressure swing adsorption unit.

13. The apparatus as claimed in one of claims 8 to 12, comprising the purification unit and means for sending the feed flow compressed in the compressor (C) to the purification unit.

14. The apparatus as claimed in one of claims 8 to 11, comprising the exchange line (E) and means for sending the feed flow compressed in the compressor (C) to the exchange line.
